(19) United States
(12) Patent Application Publication
(10) Pub. No.: US 2006/0253879 A1
(43) Pub. Date: Nov. 9, 2006

(54) Mounting system for multimedia playback devices

(75) Inventor: John G. Lin, Pacific Palisades, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Ten Technology, Inc., Sunnyvale, CA (US)

(21) Appl. No.: 11/336,628

(22) Filed: Jan. 20, 2006

Related U.S. Application Data
(60) Provisional application No. 60/645,657, filed on Jan. 20, 2005.

(51) Int. Cl. H04N 7/18

(52) U.S. Cl. 725/75; 725/77

(57) ABSTRACT

A mounting system for interfacing a multimedia playback device to an entertainment system of a vehicle. The mounting system includes a sleeve mounted to the vehicle and an insert configured to insert into the sleeve. The multimedia playback device may be an audio player such as a digital audio player, a digital multimedia playback device, a CD or DVD player, or any multimedia playback device suitable for mounting in the mounting system. The insert has an interior configured specifically to hold the shape of the multimedia playback device. A method for using the mounting system is also described.

### CLAIM OF PRIORITY UNDER 35 U.S.C. §119

The present Application for Patent claims priority to Provisional Application No. 60/645,657 entitled “Mounting System for Multimedia Playback Devices” filed Jan. 20, 2005, and assigned to the assignee hereof and hereby expressly incorporated by reference herein.

### FIELD OF THE INVENTION

The present invention relates generally to mounting and integrating electronic devices in a motor vehicle, and more particularly, to a mounting system for multimedia playback devices.

### BACKGROUND OF THE INVENTION

The advent of multimedia capable computer systems allow users to create and store their multimedia content (audio and/or video) as digital computer files. These files can then be played back using media player software on the computer or similar software on portable media players such as portable audio players. Originally, portable audio players did not include a significant amount of memory to store more than one or two compact discs (CD) worth of audio files. Thus, users would need to frequently connect them to their computer to download new media files or, if the portable audio player utilized removable storage such as memory cards, carry and manage numerous memory cards.

As portable audio players increased in storage capacity, users began to invest more time in creating and maintaining a library of digital media. More importantly, users began to carry a substantial amount of their digital media with them. In some cases, users could carry their entire library of music. Such capability allowed users to rely on their portable audio players as their sole source of entertainment, at least with respect to audio entertainment. For example, users began to listen to their portable audio players while driving their automobiles, eschewing other available audio sources such as radio, audio CD's or cassette tapes.

Typically, the portable audio player are connected to the automobile's audio system via an audio cassette adapter, which emulates an audio tape that “plays back” over the automobile's cassette player; a radio frequency (e.g., FM) transmitter, which transmits the audio signals generated by the portable audio player as a radio signal that can be received by the radio in the automobile; the “audio in” ports of the automobile's radio; the CD changer/audio player interface of the automobile's audio system. In all of these examples, a concern is the mounting of the portable audio player so as to prevent the player from being tossed around the interior of the automobile. Another concern is the recharging of the portable audio player.

Although mounting systems may be used to secure the portable audio player, a typical mounting system requires the user to place the portable audio player onto the mounting system and then also connect the various signal and power cables to the portable player. In addition, even where a mounting system includes a “docking” connector to connect to the portable audio player to the wiring of the automobile's audio system, it is a proprietary connector that is custom to the particular portable audio player to be used. Thus, if the user changes the portable audio player, a new mounting system and, consequently, a new wiring harness needs to be integrated. Further, without knowing which model of portable audio player the user will be using, automobile manufacturers cannot include a mounting system without requiring the user to purchase the same model of portable audio player.

Accordingly, there is a need to overcome the issues noted above.

### SUMMARY OF THE PREFERRED EMBODIMENTS

The present invention provides a mounting system for interfacing a multimedia playback device to an entertainment system of a vehicle. The mounting system includes a sleeve mounted to the vehicle and an insert configured to insert into the sleeve. The multimedia playback device may be an audio player such as a digital audio player, a digital multimedia playback device, a CD or DVD player, or any multimedia playback device suitable for mounting in the mounting system. The insert has an interior configured specifically to hold the shape of the multimedia playback device.

In one preferred embodiment of the present invention, a method is provided for interfacing a multimedia player device to an entertainment system in a vehicle. The method includes the steps of installing a sleeve in the vehicle, the sleeve having an interface circuit coupled to the entertainment system; disengageably locking an insert into the sleeve, the insert having an interior configured to receive the multimedia player device; and, inserting the multimedia player device into the interior of the sleeve.

In another embodiment of the present invention, a mounting system is provided for a vehicle compartment having an entertainment system, the entertainment system including an interface for communicating with the entertainment system. The mounting system includes a sleeve mounted to the vehicle compartment, the sleeve having an inner portion and an opening disposed on one wall thereon; an insert having an outer portion configured to slide into and be retained by the inner portion of the sleeve through the opening and a locking mechanism configured to disengageably couple the insert to the sleeve, the insert also including an inner portion configured to receive a multimedia playback device; and, a device interface circuit coupled to the sleeve, the device interface circuit providing an interface between the entertainment system and the multimedia playback device.

Other features of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which:

FIG. 1 is an exploded perspective view of a mounting system for an audio player configured in accordance to a preferred embodiment of the present invention, the mounting system including a sleeve and an insert;

FIG. 2 is a perspective view of the mounting system of FIG. 1 where the insert has been installed into the sleeve;

FIG. 3 is a perspective view of the mounting system of FIG. 1 where the audio player has been inserted into the installed insert;

FIG. 4 is a perspective cross-sectional view of the mounting system of FIG. 1 where the insert has been installed into the sleeve, taken along line IV-IV of FIG. 2;

FIG. 5 is a perspective view an automobile glove box in which the sleeve of the mounting system of FIG. 1 may be installed in accordance with one embodiment of the present invention;

FIG. 6 is a front elevational view of the sleeve of the mounting system of FIG. 1 installed in the automobile glove box in accordance with one embodiment of the present invention;

FIG. 7 is a top plan view of a sleeve of the mounting system of FIG. 1 configured in accordance with one embodiment of the present invention;

FIG. 8 is a bottom plan view of the sleeve of the mounting system of FIG. 1;

FIG. 9 is a left elevational view of the sleeve of the mounting system of FIG. 1;

FIG. 10 is a right elevational view of the sleeve of the mounting system of FIG. 1;

FIG. 11 is a front elevational view of the sleeve of the mounting system of FIG. 1;

FIG. 12 is a back elevational view of the sleeve of the mounting system of FIG. 1;

FIG. 13 is a cross-sectional view of the sleeve of the mounting system of FIG. 1, taken along line XIII-XIII of FIG. 12, illustrating an electronic assembly contained therein;

FIG. 14 is a perspective view of the sleeve of the mounting system of FIG. 1, with a cut-away illustrating the electronic assembly contained therein;

FIG. 15 is a top plan view of an insert of the mounting system of FIG. 1 configured in accordance with one embodiment of the present invention;

FIG. 16 is a bottom plan view of the insert of the mounting system of FIG. 1;

FIG. 17 is a left elevational view of the insert of the mounting system of FIG. 1;

FIG. 18 is a right elevational view of the insert of the mounting system of FIG. 1;

FIG. 19 is a front elevational view of the insert of the mounting system of FIG. 1;

FIG. 20 is a back elevational view of the insert of the mounting system of FIG. 1;

FIG. 21 is a top plan view of a second insert usable in the mounting system of FIG. 1 configured in accordance with a second embodiment of the present invention;

FIG. 22 is a bottom plan view of the second insert of FIG. 21;

FIG. 23 is a left elevational view of the second insert of FIG. 21;

FIG. 24 is a right elevational view of the second insert of FIG. 21;

FIG. 25 is a front elevational view of the second insert of FIG. 21;

FIG. 26 is a back elevational view of the second insert of FIG. 21;

FIG. 27 is an exploded perspective view of a second mounting system for the audio player configured in accordance to another preferred embodiment of the present invention, the mounting system including a sleeve and an insert;

FIG. 28 is a perspective view of the mounting system of FIG. 27 where the insert has been installed into the sleeve;

FIG. 29 is a second perspective view of the mounting system of FIG. 27 where the insert has been installed into the sleeve;

FIG. 30 is a top plan view of a base of the sleeve of the mounting system of FIG. 27 configured in accordance with one embodiment of the present invention;

FIG. 31 is a bottom plan view of a top cover of the sleeve of the mounting system of FIG. 27 configured in accordance with one embodiment of the present invention;

FIG. 32 FIG. 35 are various perspective views of the sleeve of the mounting system of FIG. 27 configured in accordance with one embodiment of the present invention, including cut-away portions to illustrate the various internal components.

Like numerals refer to like parts throughout the several views of the drawings.

### DETAILED DESCRIPTION OF THE PREFERRED EMBODIMENTS

The present invention is a mounting system for integrating a digital audio playback device such as the Apple iPod™ digital audio player with an in-car entertainment system. The mounting system can accommodate a variety of models, each having a different physical size. Preferably, the mounting system is fixed in a protected location such as a glove/map compartment and may withstand the vehicle environment. Further, the mounting system contains interfacing electronics to provide communications between the audio player and the vehicle's electrical system.

In one embodiment of the present invention, through the use of different inserts, where each insert has an outer surface that fits into a common sleeve but each insert having an internal chamber designed to accommodate a respective playback device, various models and types of playback devices may be supported through the use of this common sleeve. Thus, the sleeve of the mounting system may be preinstalled in the automobile, reducing the amount of effort to integrate a playback device.

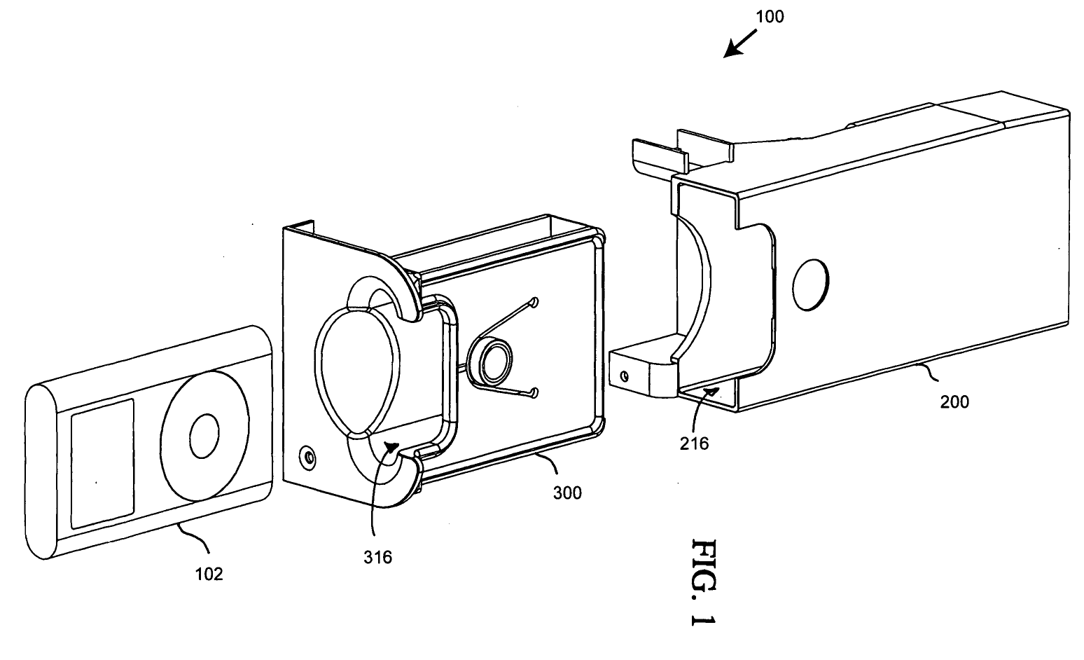

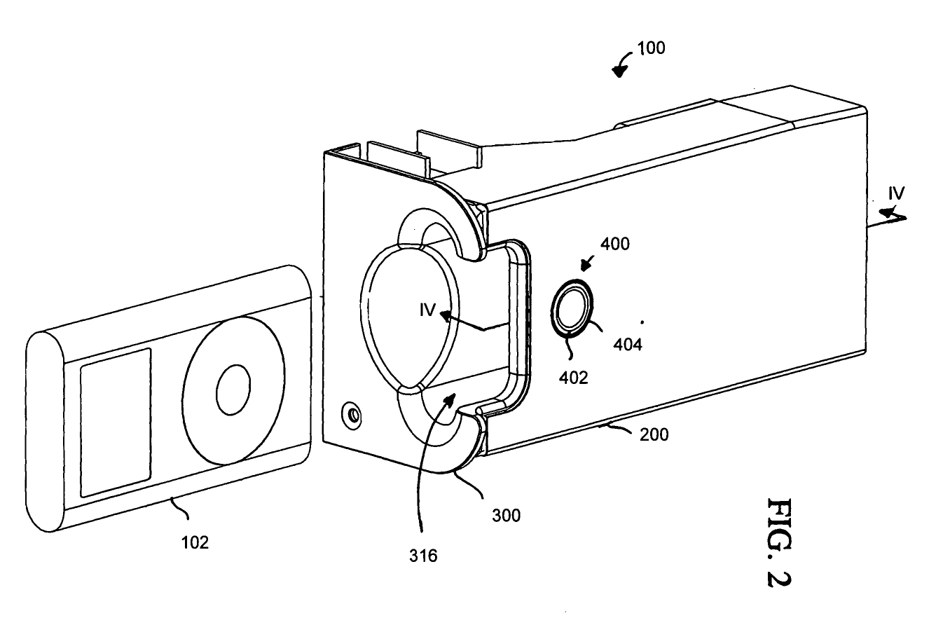

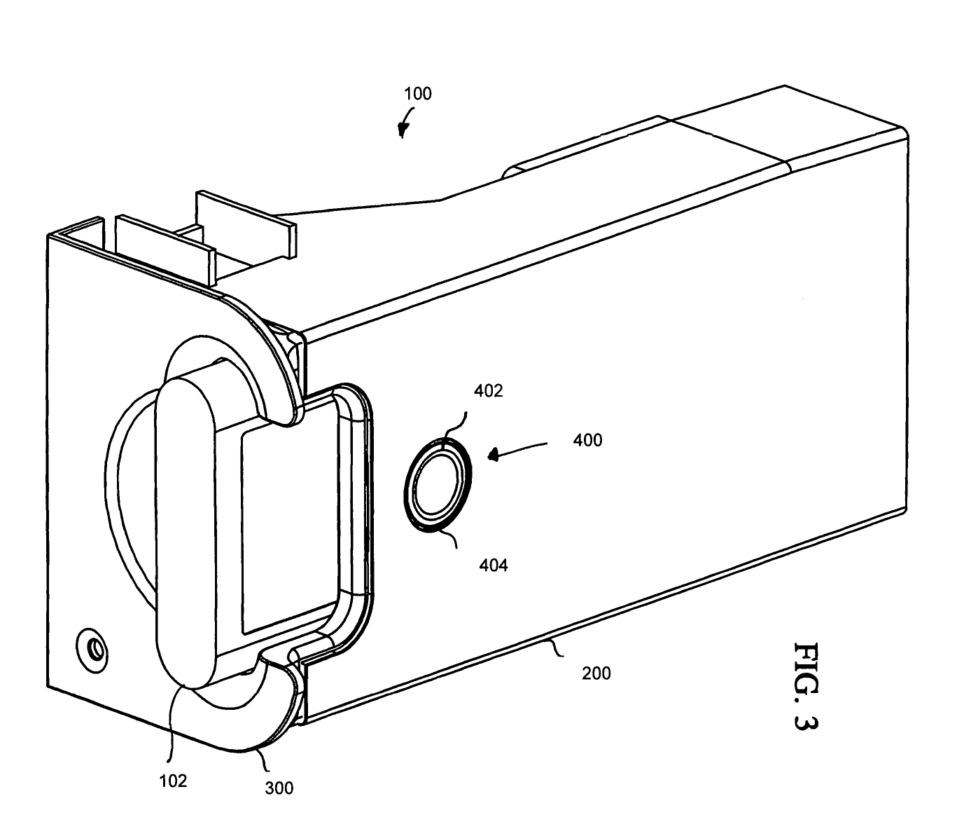

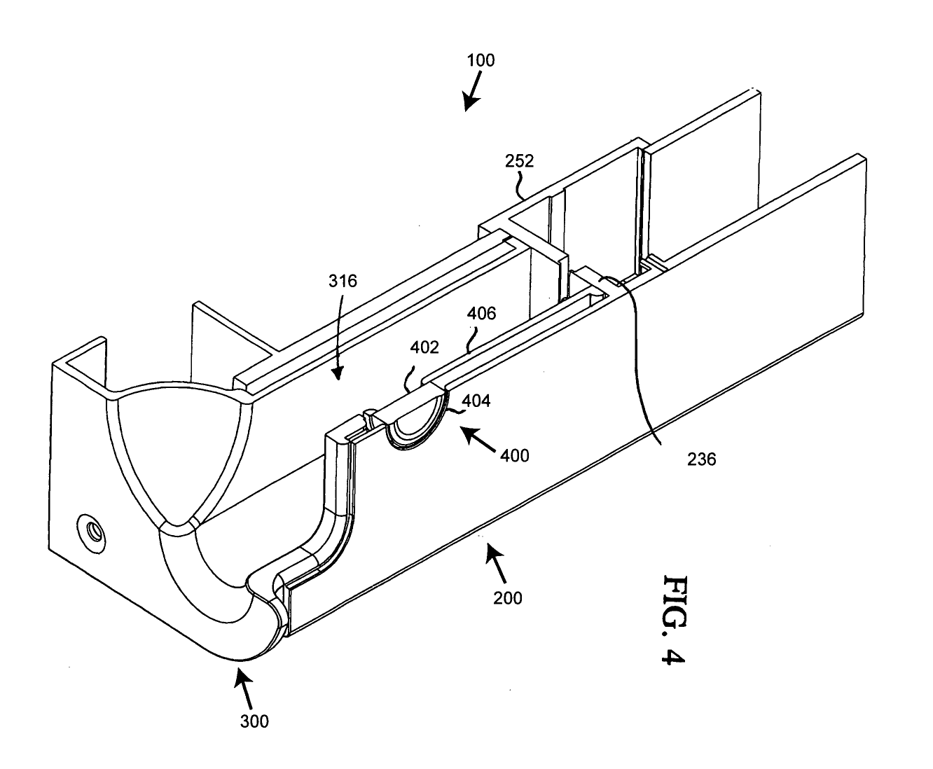

FIG. 1 illustrates a mounting system 100 configured in accordance with one embodiment of the present invention, including a sleeve 200, and an insert 300. Mounting system 100 is designed to retain a multimedia playback device such an audio player 102. As described herein, sleeve 200 is mounted to a portion of an interior of an automobile. Insert 300 is then inserted into sleeve 200 and secured via an insert retaining mechanism 400, as shown in FIG. 2. When the user desires to couple audio player 102 to the audio system of the automobile, the user can then insert audio player 102 into insert 300, as shown in FIG. 3.

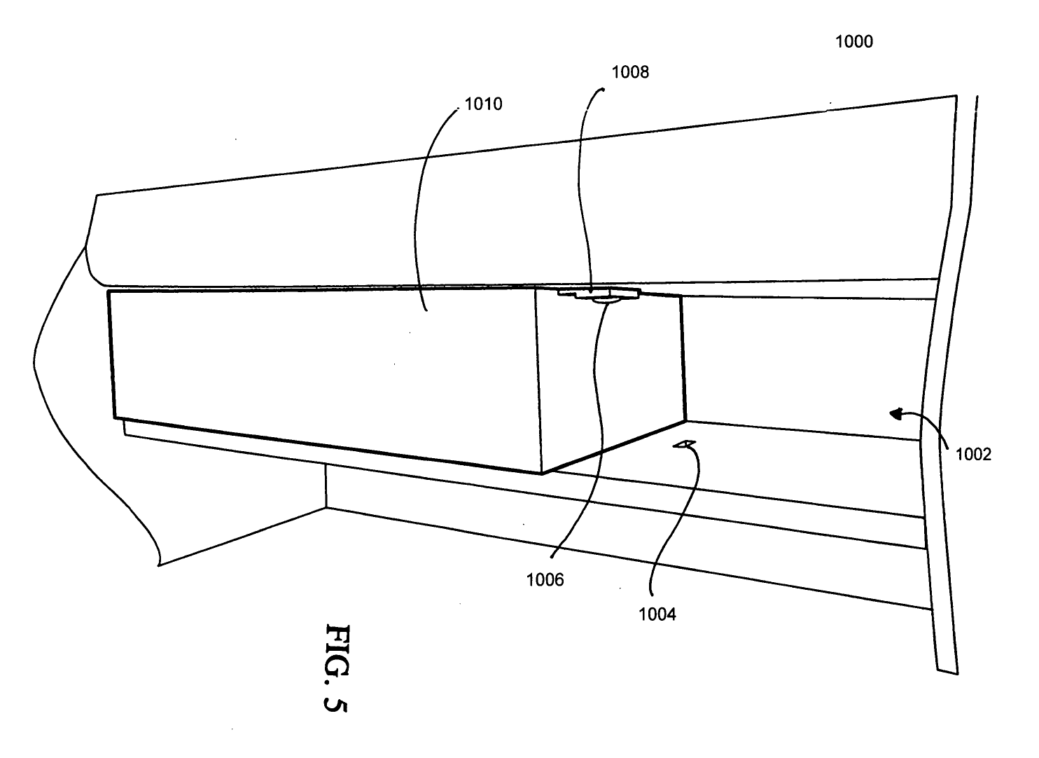

FIG. 4 illustrates the coupling between insert 300 and sleeve 200, with insert retaining mechanism 400 holding insert 300 in sleeve 200. Insert retaining mechanism 400 includes a plug 402 in insert 300 and an opening 404 in sleeve 200. Plug 402 fits into opening 404 to retain insert 300 in sleeve 200. In one embodiment, plug 402 is cylindrical in shape and opening 404 is circular in shape to match the cross section of plug 402. Plug 402 is attached to insert 300 via a mounting arm 406 that allows plug 402 to be disengaged from opening 404. In other embodiments, plug 402 and opening 404 may be shaped differently, but complement each other to retain plug 402 in opening 404. Sleeve 400 also includes a channel 218 to guide plug 402 in fitting into opening 404. Further, in another embodiment, a different mechanism for insert retention may be used. For example, a latch mechanism, a screw fastener or a hook and loop-type fastener may be used.

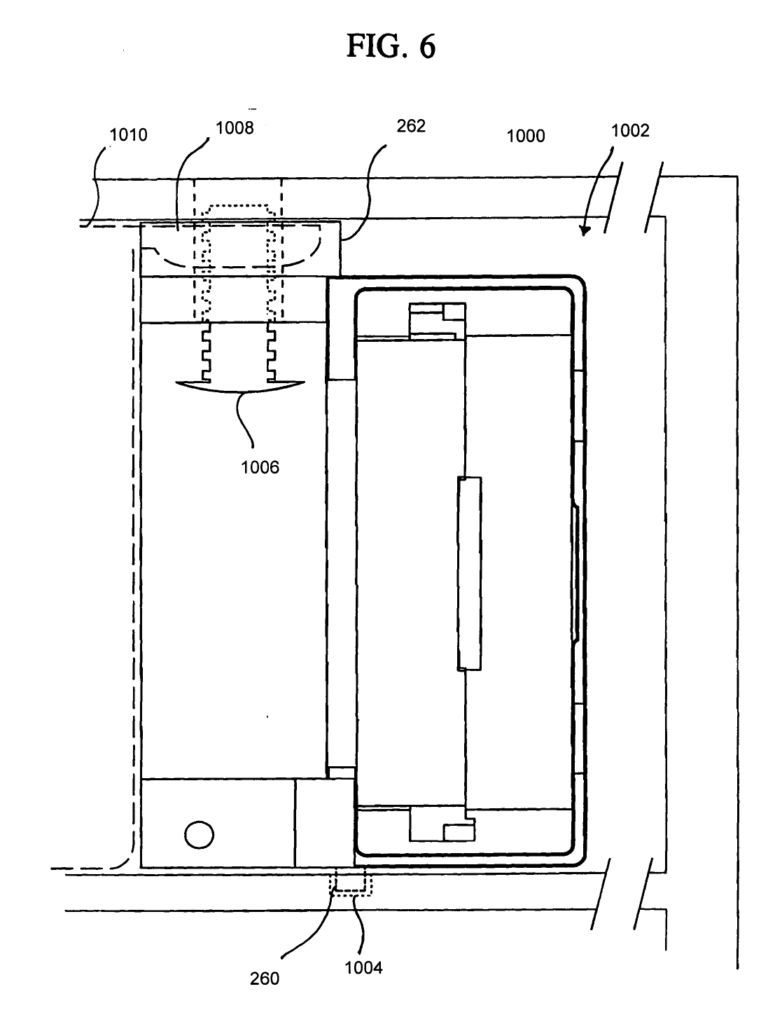

FIG. 5 illustrates an interior 1002 of a glove compartment 1000 in which mounting system 100 may be used. As illustrated in the figure, a CD-changer 1010 is mounted to glove compartment 1000 with a mounting bolt 1006 fastened to tab 1008. Glove compartment 1000 also includes an opening 1004 that is used by the mounting system of the present invention to secure sleeve 200. FIG. 6 illustrates a detail of the mounting of mounting system 100 to glove compartment 1000, where sleeve 200 includes a mounting tab 262 through which mounting bolt 1006 is inserted to secure sleeve 200 to glove compartment 1000. As also seen in the figure, an alignment stub 260 from sleeve 200 is inserted into opening 1004. By bolting mounting tab 262 to glove compartment 1000 and using alignment stub 260, sleeve 200 is prevented from rotating in interior 1002 of glove compartment 1000.

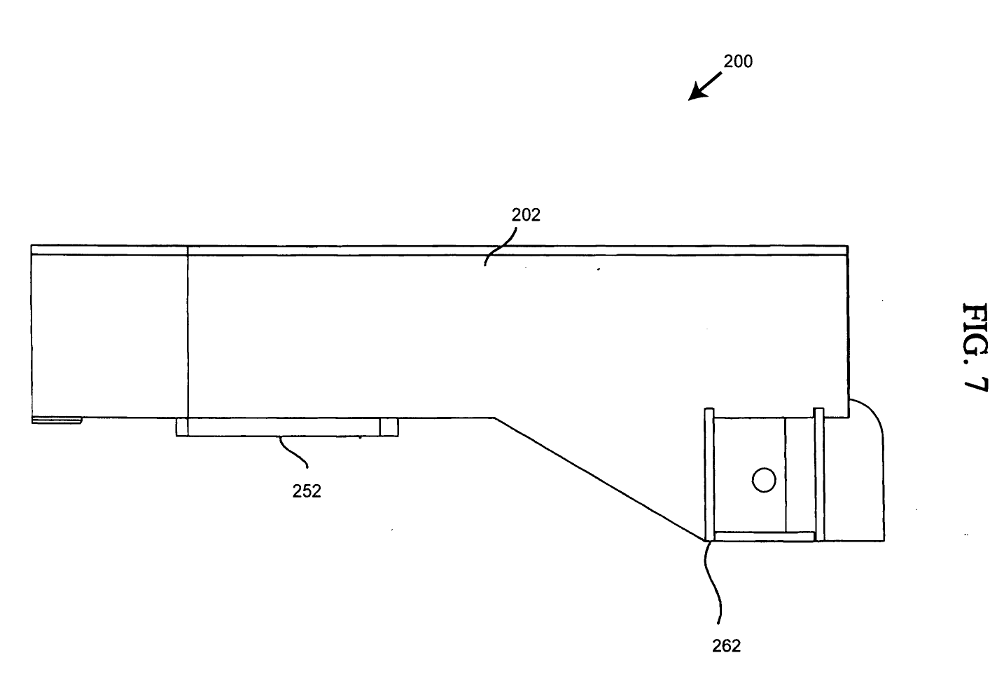

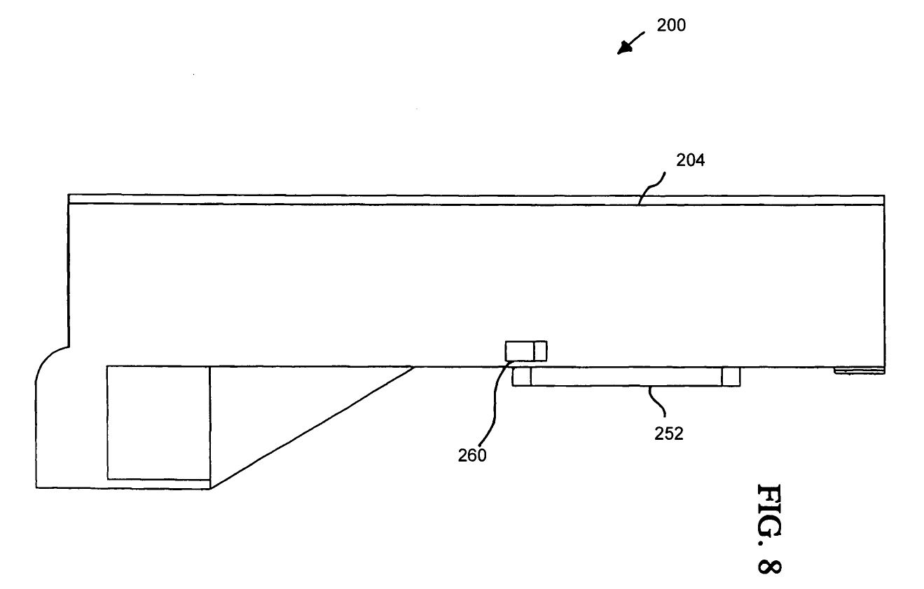

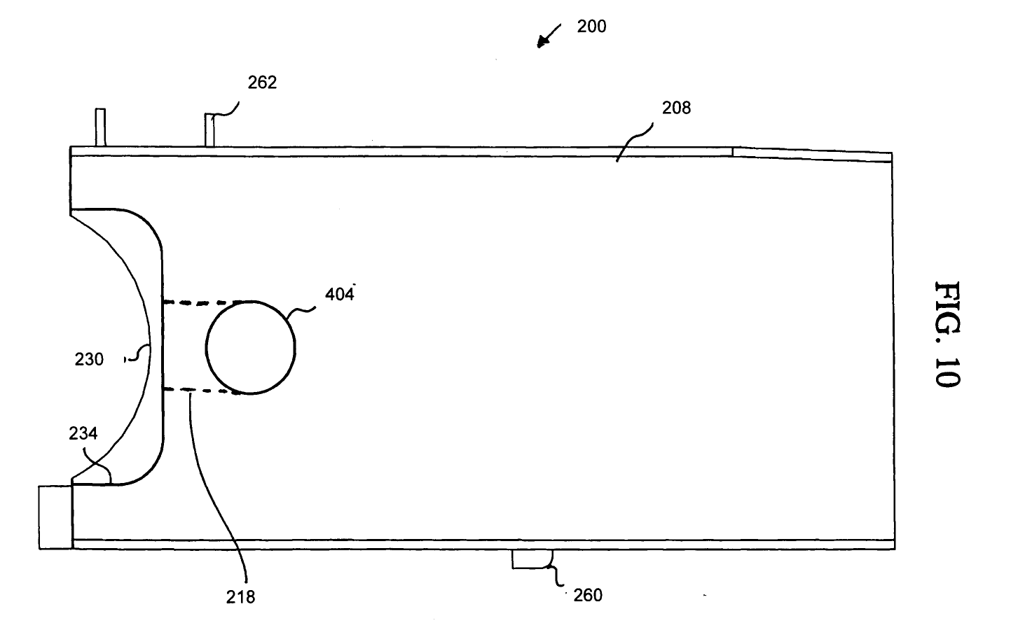

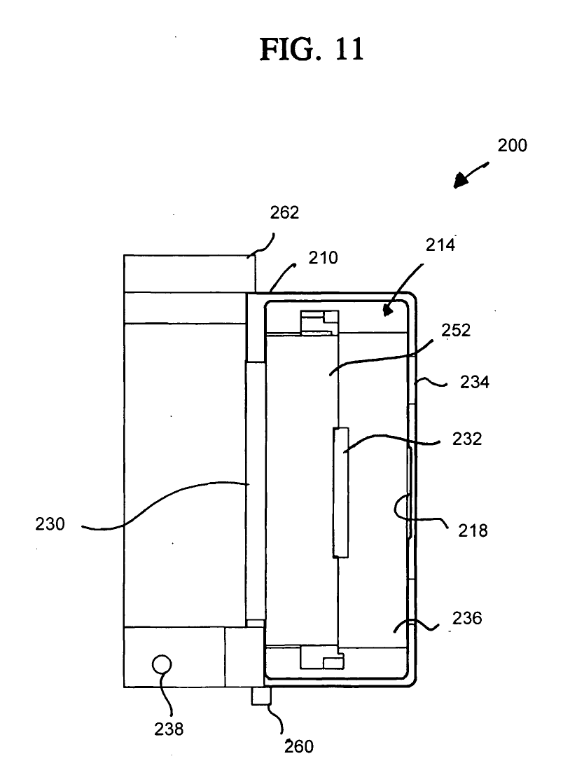

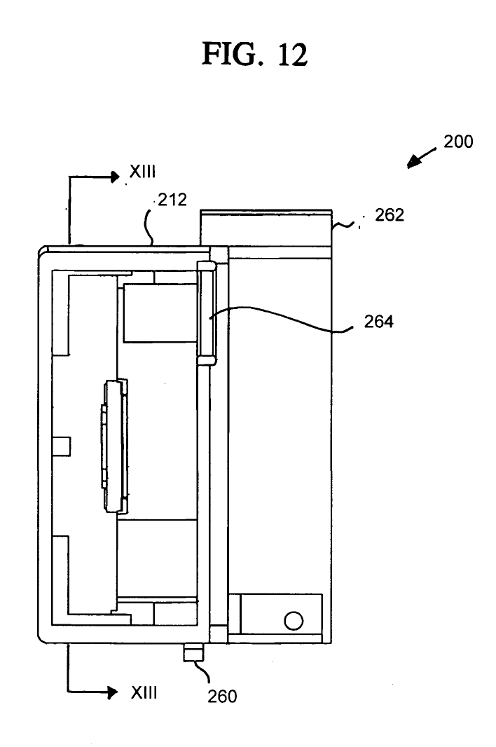

FIG. 7 to FIG. 12 illustrates the various parts of sleeve 200, including a top surface 202, a bottom surface 204, a left surface 206, a right surface 208, a front surface 210 and a back surface 212. Front surface 210 of sleeve 200 includes a front opening 214 that is sized to match the cross-section of the outer shape of insert 300 along the long length of insert 300. In addition, insert 300 fits into an interior 216 of sleeve 200 that is sized to contain insert 300.

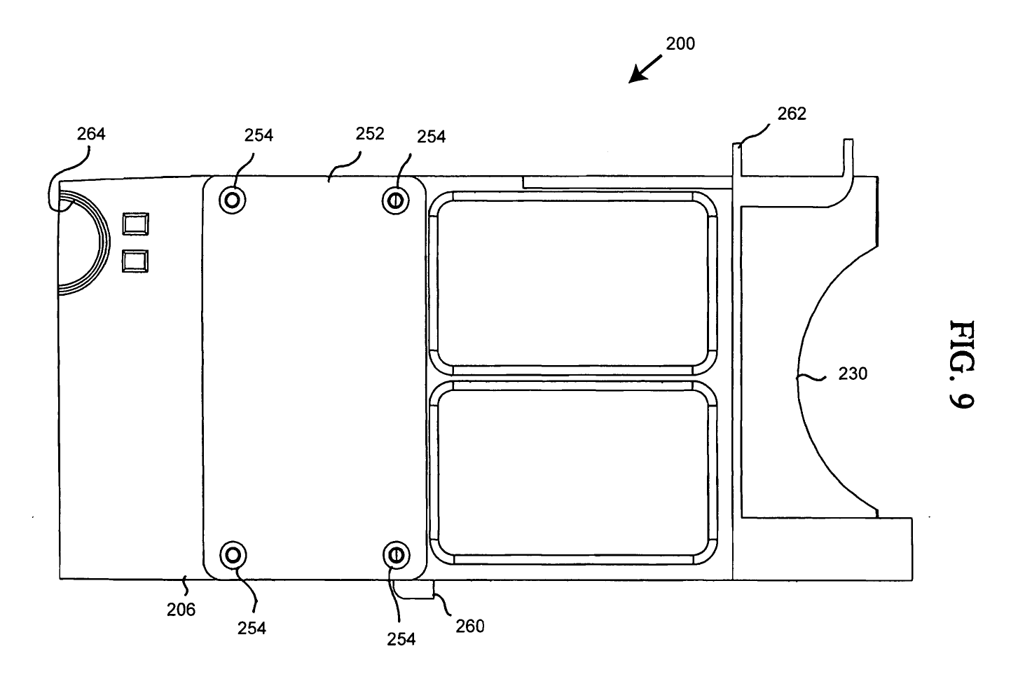

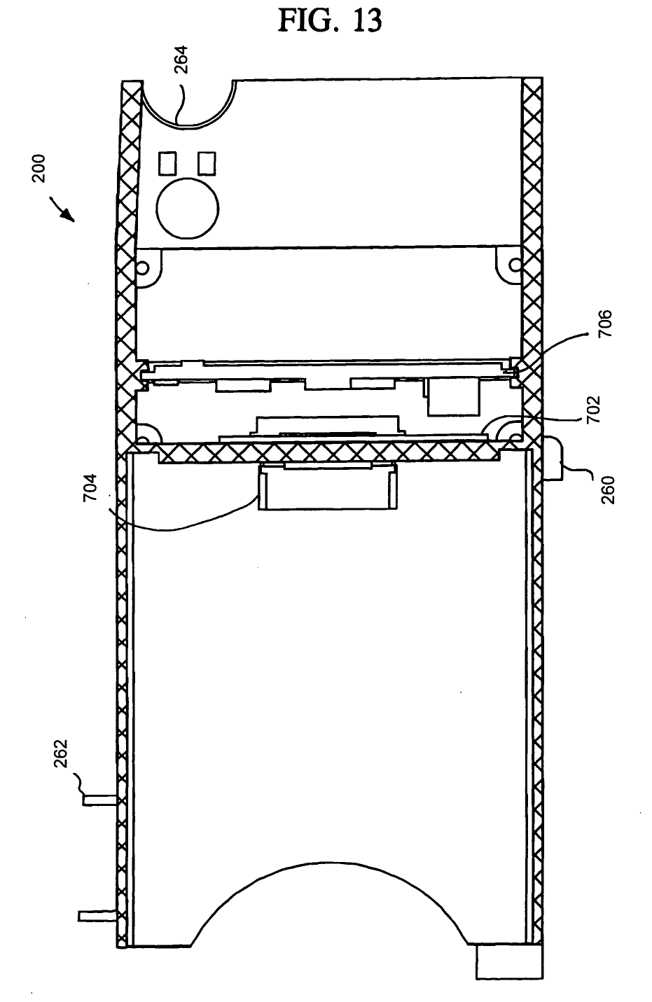

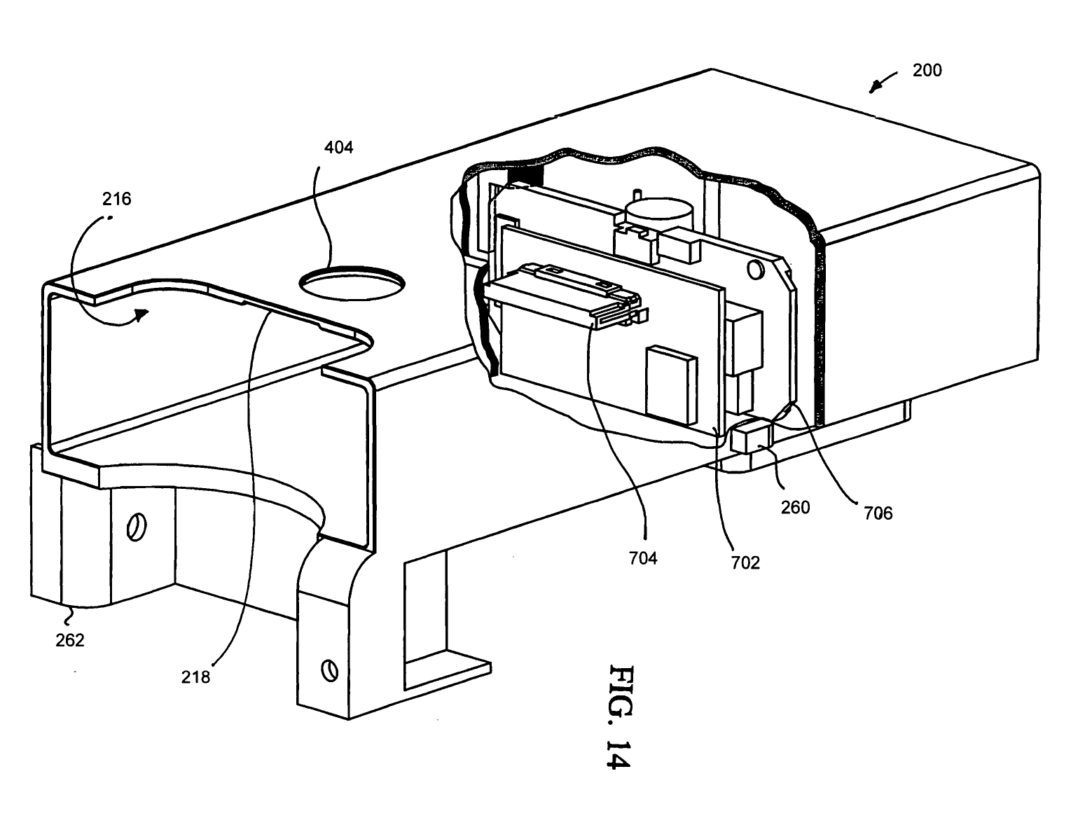

As shown in FIG. 9, sleeve 200 includes a door 252 that, when removed, allows access to interior 216 of the sleeve 200. A connector circuit board 702 and an interface circuit board 706 connected to connector circuit board 702 are mounted on door 252. Door 252 is secured to sleeve 200 by a plurality of fasteners 254. Door 252 cooperates with an internal wall 236 in sleeve 200 to define a connector opening 232 through which connector on audio player 102 (not shown) connects to a matched connector 704 on connector circuit board 702 when audio player 102 is inserted into insert 300 (see FIG. 13 and FIG. 14). Interface circuit board 706 includes the circuitry necessary to interface audio player 102 to the electrical system of the automobile as well as circuitry for any auxiliary functions. In another embodiment, instead of using an electro/mechanical interface to interface audio player 102 to the electrical system of the automobile, interface circuit board 706 may contain a wireless interface such as a Bluetooth or wireless Ethernet interface.

Interface circuit board also contains circuitry for other purposes as well. For example, sleeve 200 includes an opening 238 for a light emitting diode (LED) (not shown) that indicates whether audio player 102 is properly connected. In another embodiment, the LED may be indicative of the status of connection of insert 300 with sleeve 200, as well as the connectivity of audio player 102. Multiple LED's and indicators may also be used. In addition to providing informational display circuitry, interface circuit board 706 may also include power regulation circuitry for recharging audio player 102. The cables and wires (not shown) for the electronics on sleeve 200 exit a cable opening 264 to attach to the electrical system of the automobile.

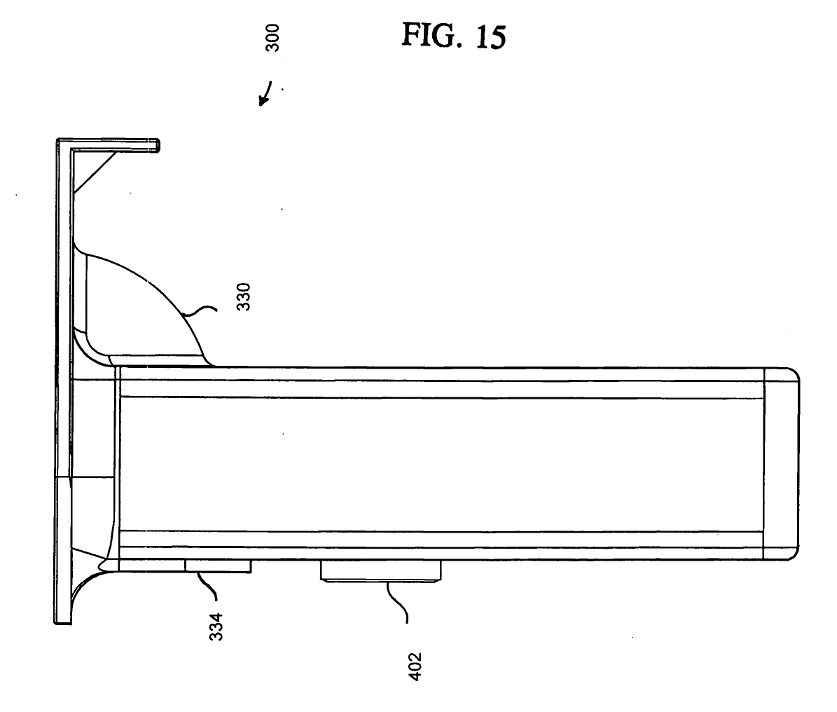

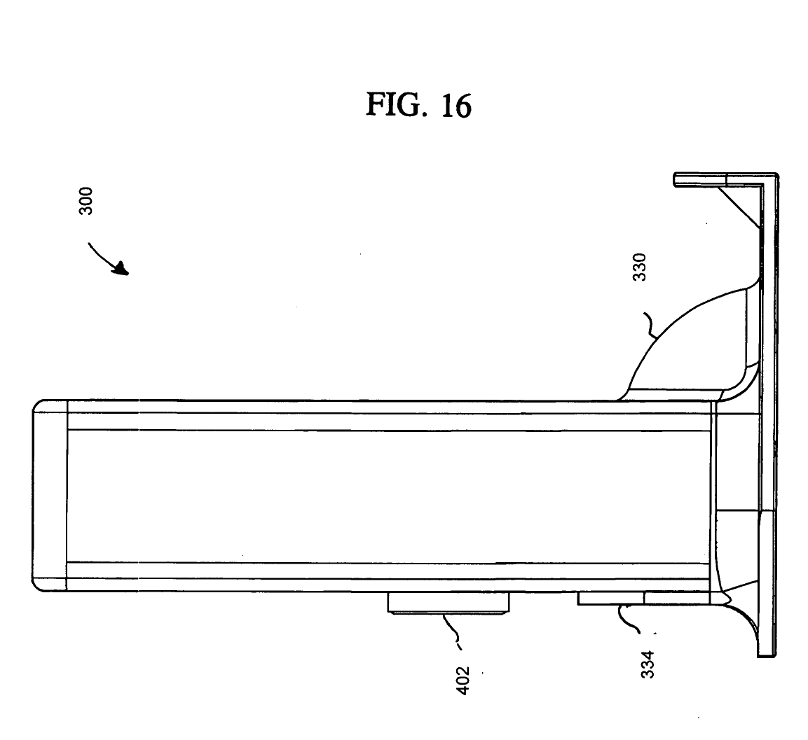

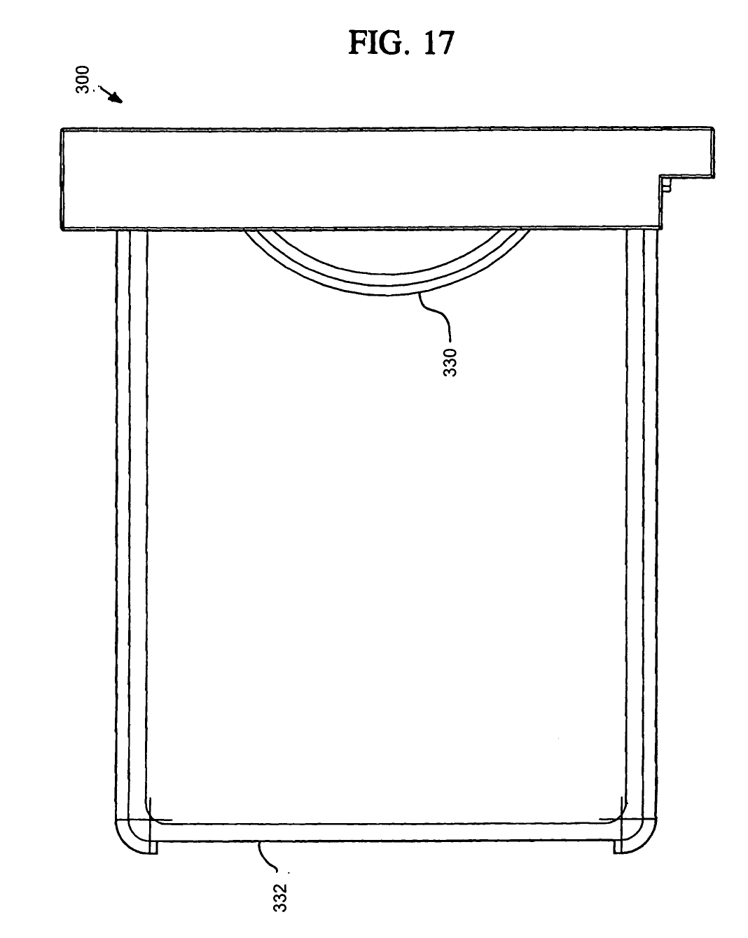

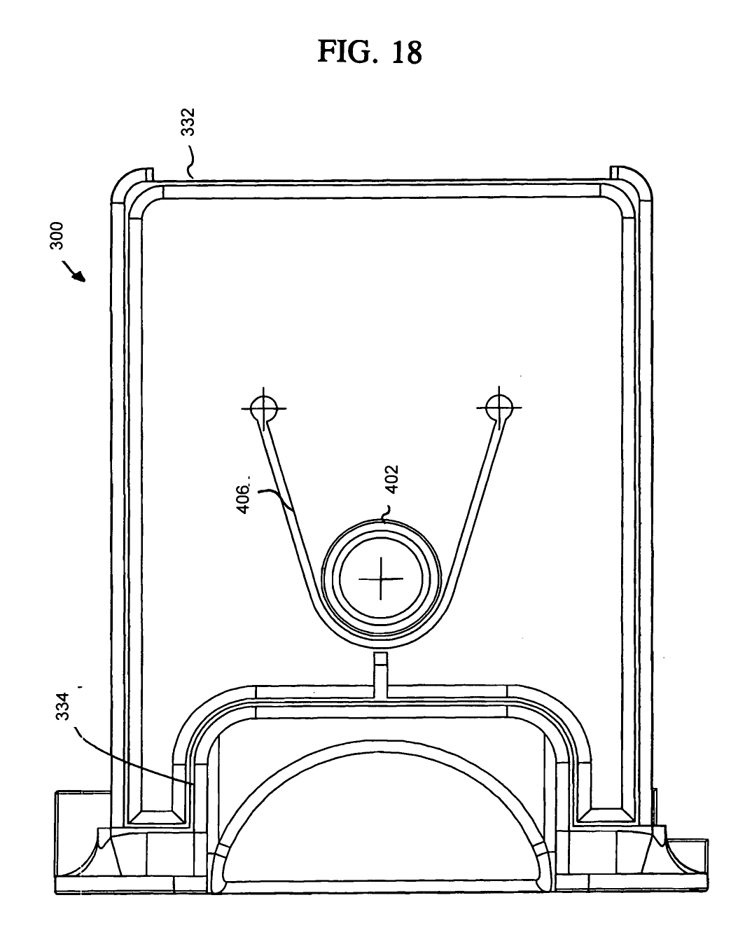

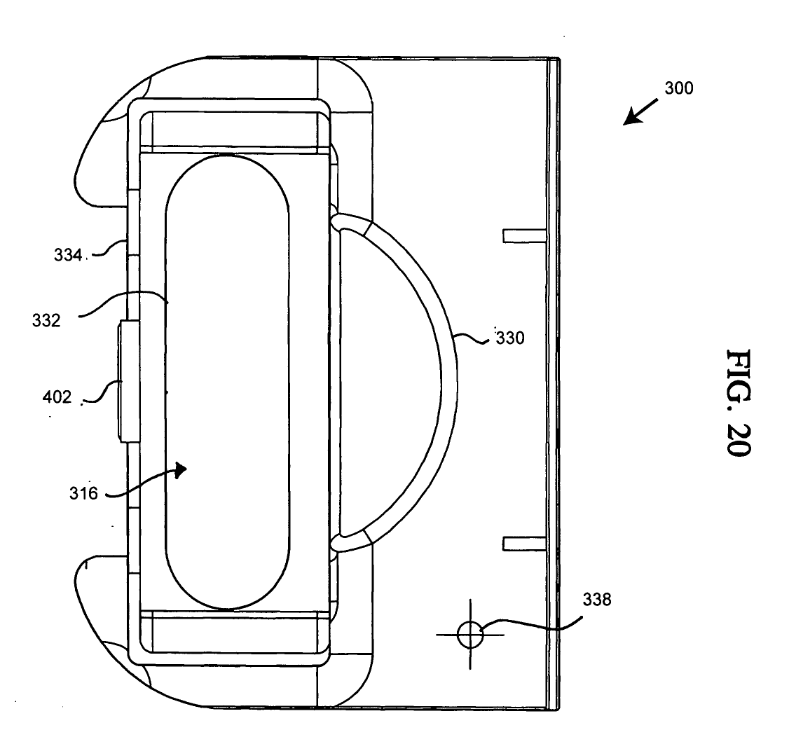

FIG. 15 to FIG. 20 illustrates the various parts of insert 300, including a top surface 302, a bottom surface 304, a left surface 306, a right surface 308, a front surface 310 and a back surface 312. As discussed above, the exterior of the rear portion of insert 300 is sized to pass through front opening 214 and insert 300 is configured to fit into interior 216 of sleeve 200. Insert 300 includes a lipped portion 334 that is insertable into a notched portion 234 on sleeve 200. In addition, a curved surface 330 fits into a semi-circular cutout 230. Referring back to FIG. 3, curved surface 330 and the opening defined by lipped portion 334 exposes a portion of audio player 102 so that the user may more easily hold onto audio player 102 so as to insert and remove it.

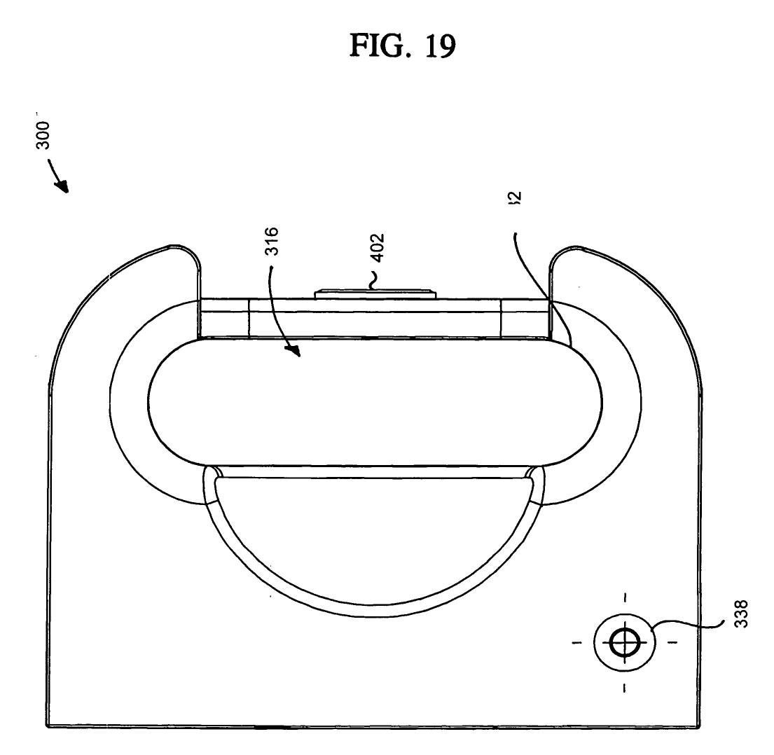

Similar to the fashion that sleeve 200 is sized to retain insert 300, front surface 302 of insert 300 includes a front opening 314 that is sized to match the outer shape of audio player 102. Further, insert 300 also includes an interior 316 that is specifically shaped to retain audio player 102. In one embodiment, audio player 102 is retained by the force exerted on the player by the forces between the connector on audio player 102 and the matched connector on sleeve 200, as well as the friction between the surfaces of audio player 102 and interior 316 of insert 300. In another embodiment, a retaining mechanism such as a lip or latch may be used to retain audio player 102 in insert 300 and ensure a more secure connection between audio player 102 and mounting system 100. As seen in FIG. 19, front surface 302 of insert 300 includes a LED pass-through port 338 that allows the LED coupled to interface circuit board 706 mounted in sleeve 200 to show through front surface 302.

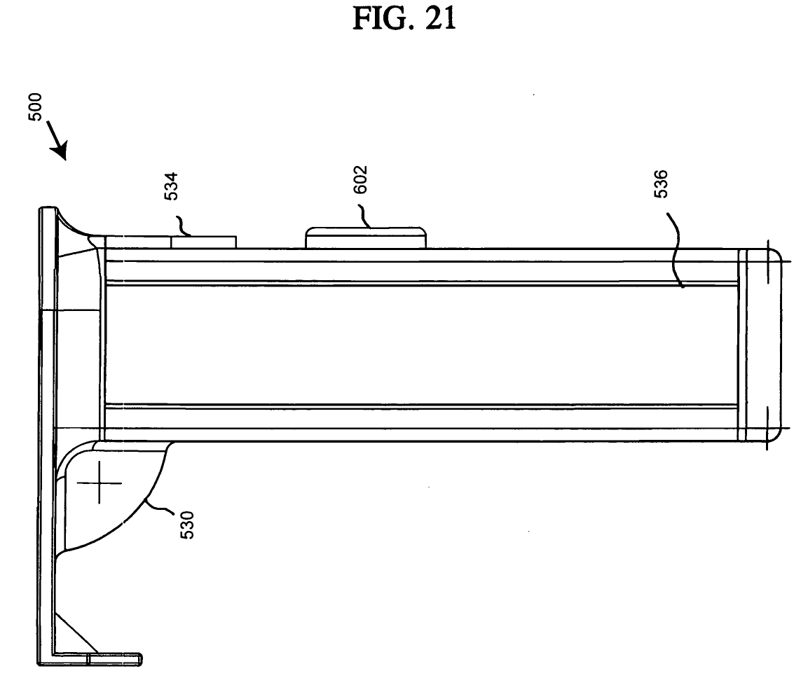

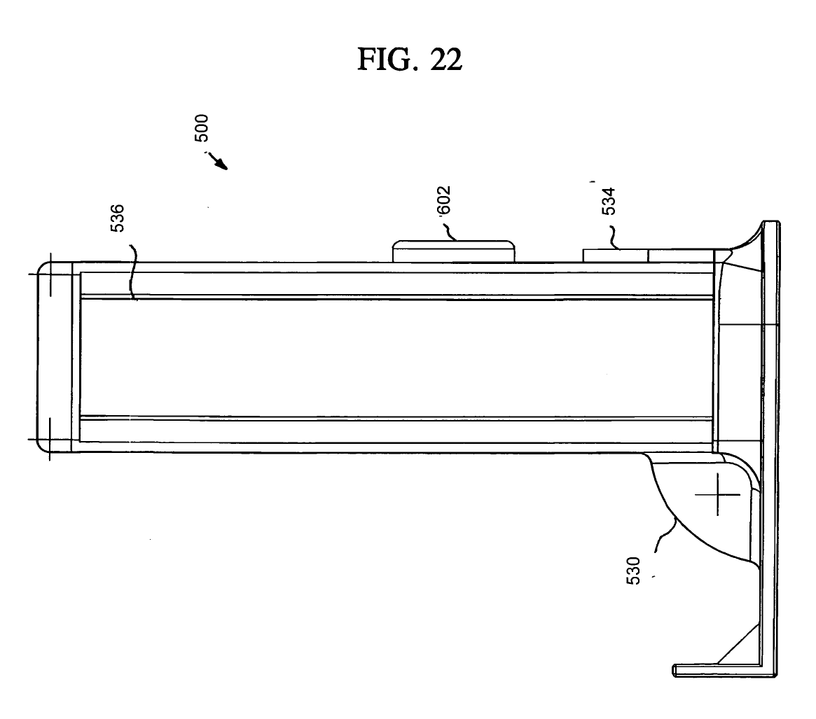

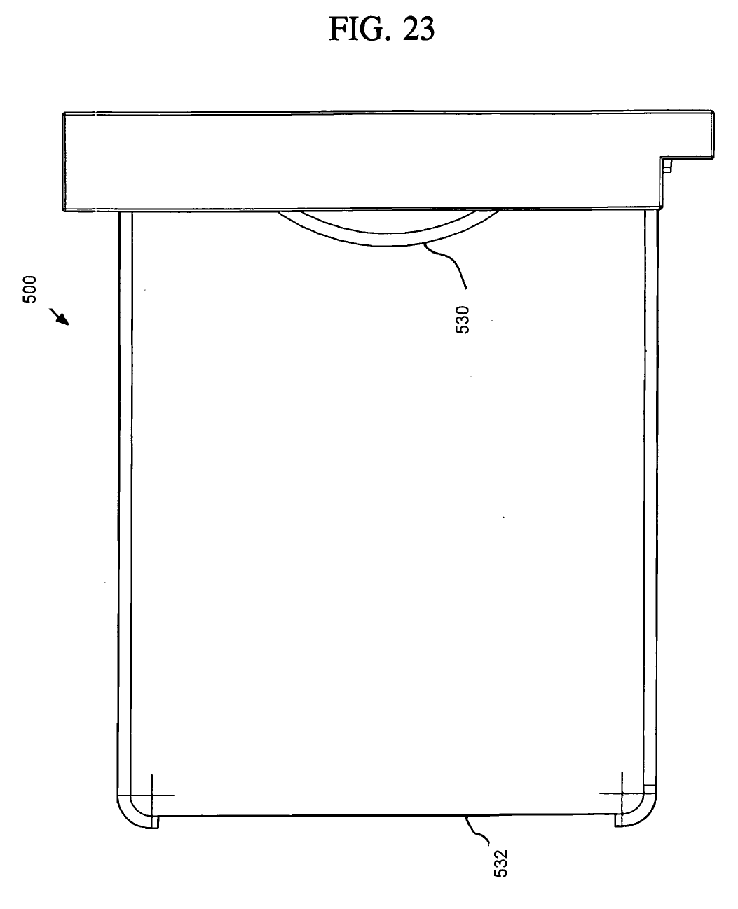

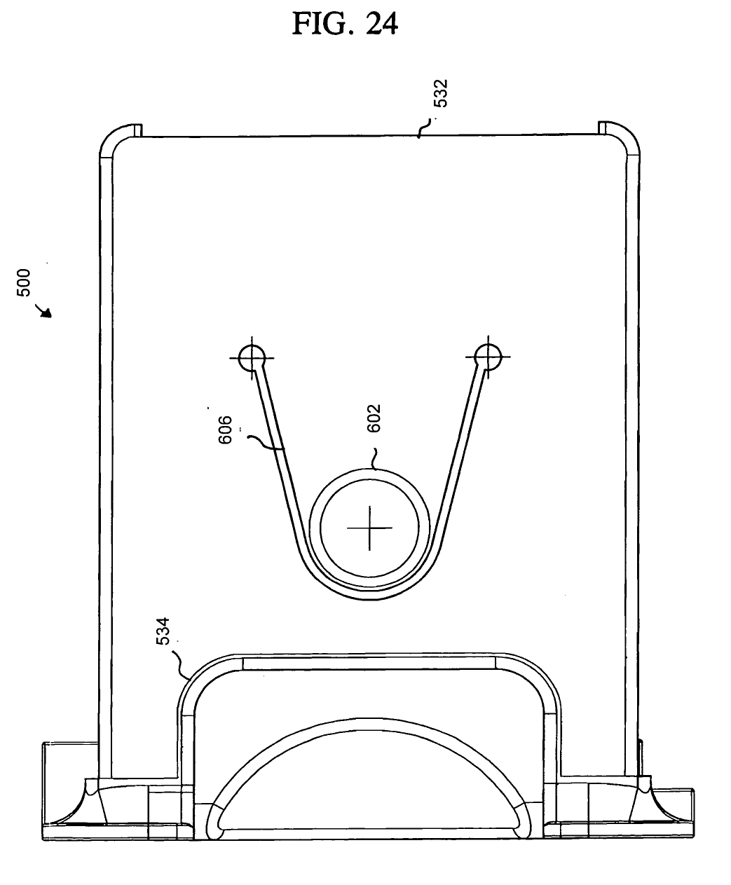

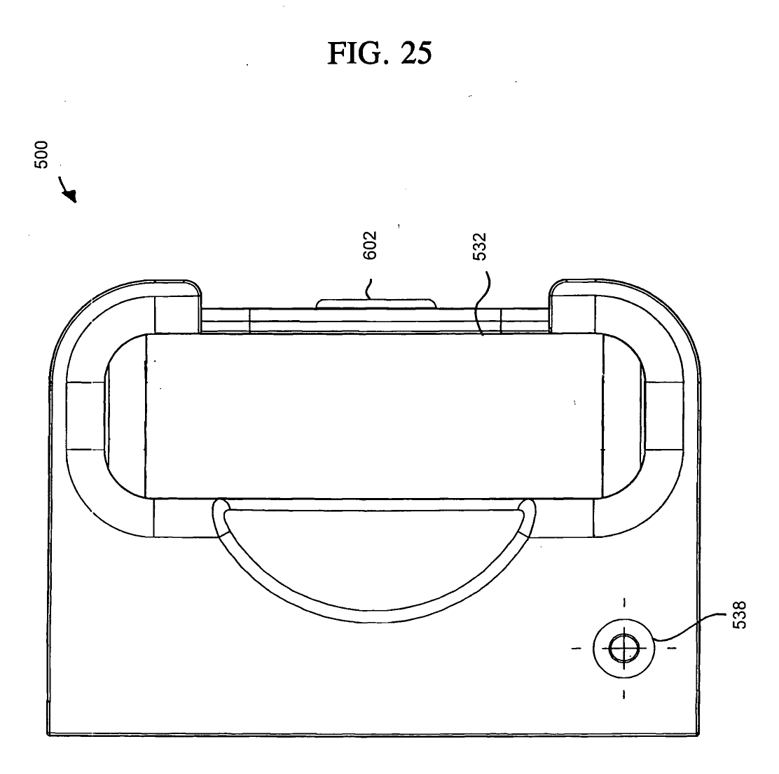

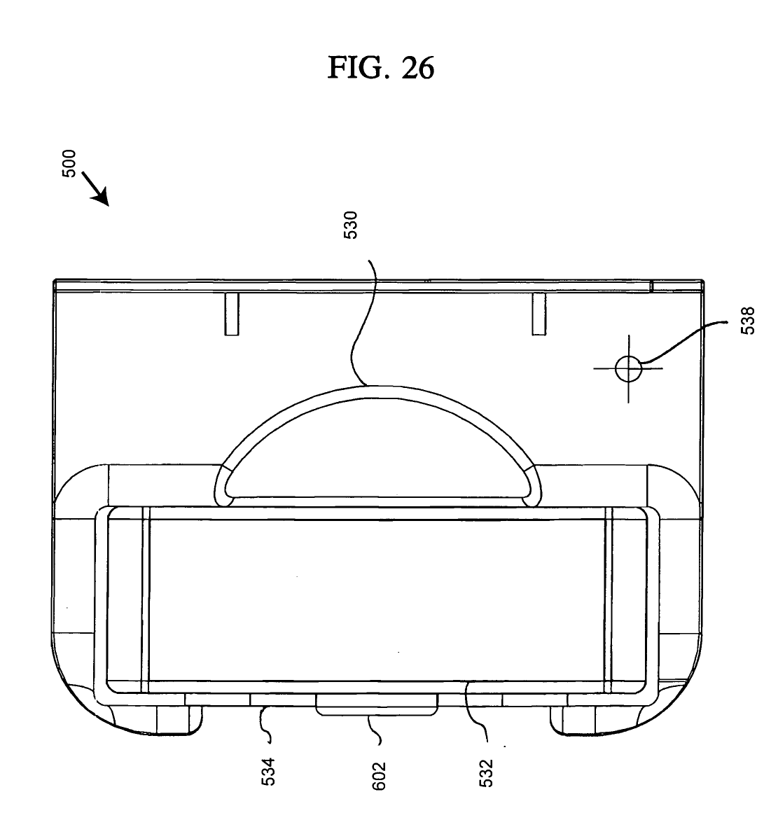

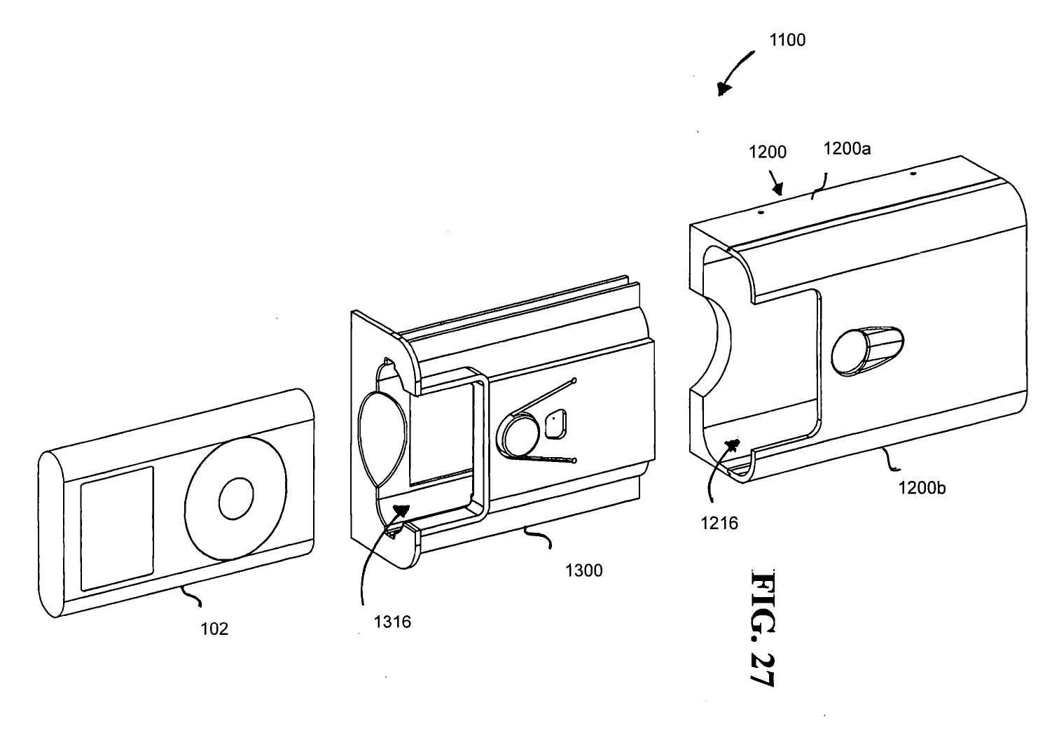

FIG. 21 to FIG. 26 illustrates the various parts of a second insert 500 that, similar to insert 200, is configured to insert into and be retained by sleeve 300. Second insert 500 including a top surface 502, a bottom surface 504, left surface 506, right surface 508, front surface 510 and back surface 512. Second insert 500 is sized to accommodate a different audio player (not shown), includes a front opening 514 that is sized to match the outer shape of the different audio player. Through the use of different inserts, various models of audio players may be supported by mounting system 100 and thus interfaced with the electrical system of the automobile.

It should be noted that although the use of mounting system 100 has been with respect an audio player, mounting system 100 may be used with other types of devices that need to be coupled to the electrical system of the automobile as well. For example, with the increase of flat panel displays being integrated into the entertainment systems of automobiles, it is expected that users will begin to use portable digital media players to play back video media files as well, thereby further increasing users' reliance on these players.

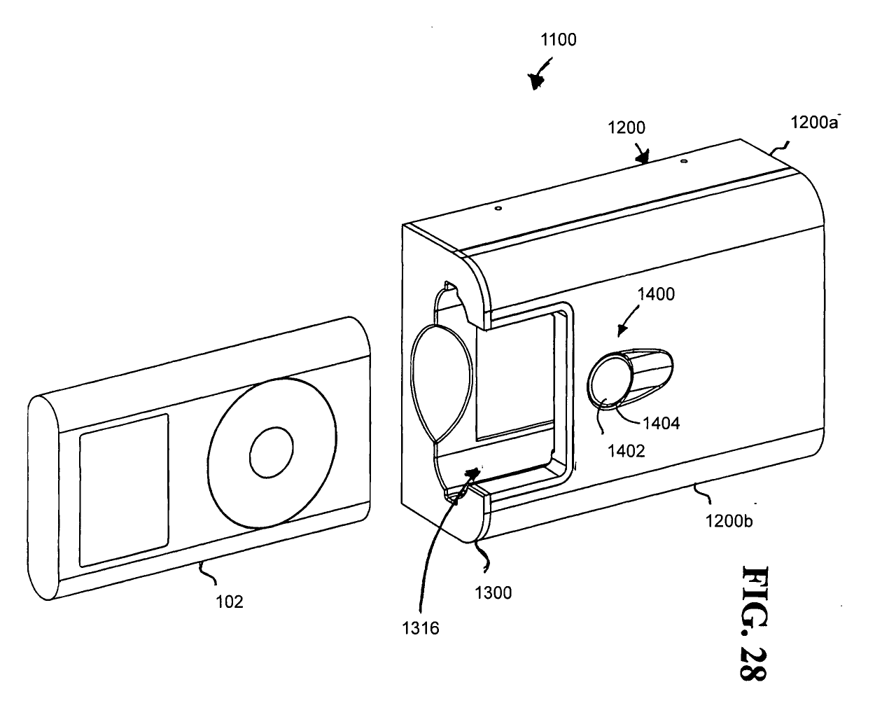

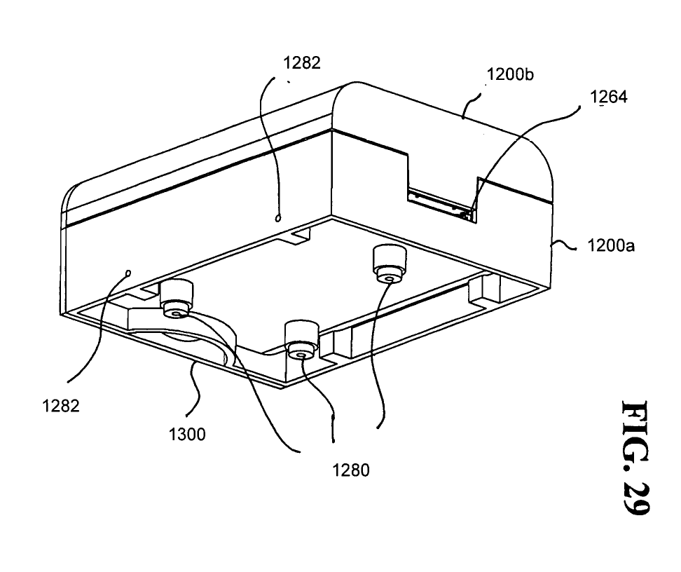

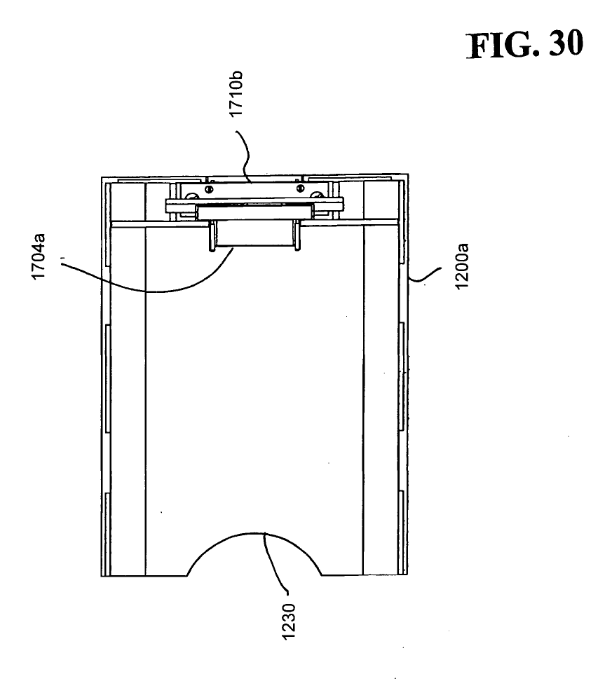

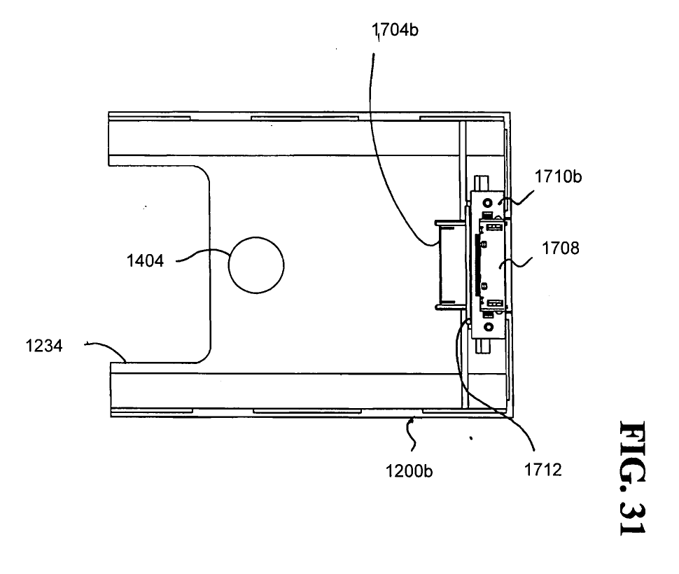

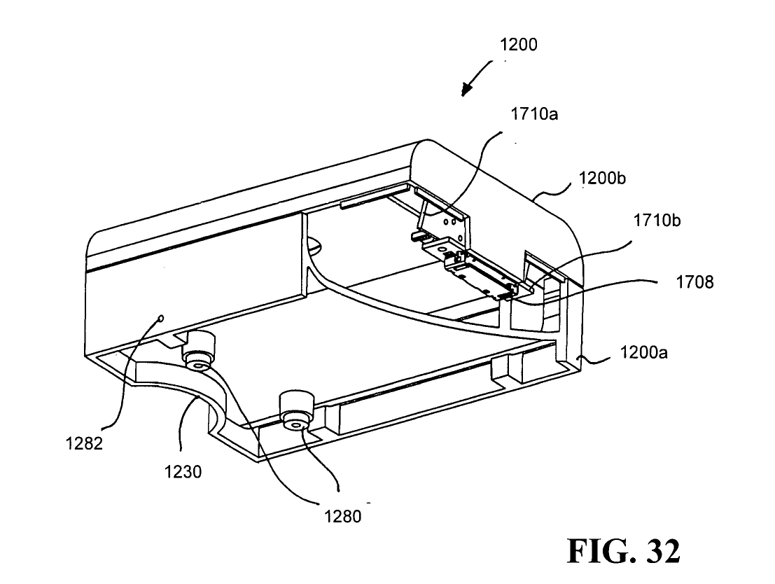

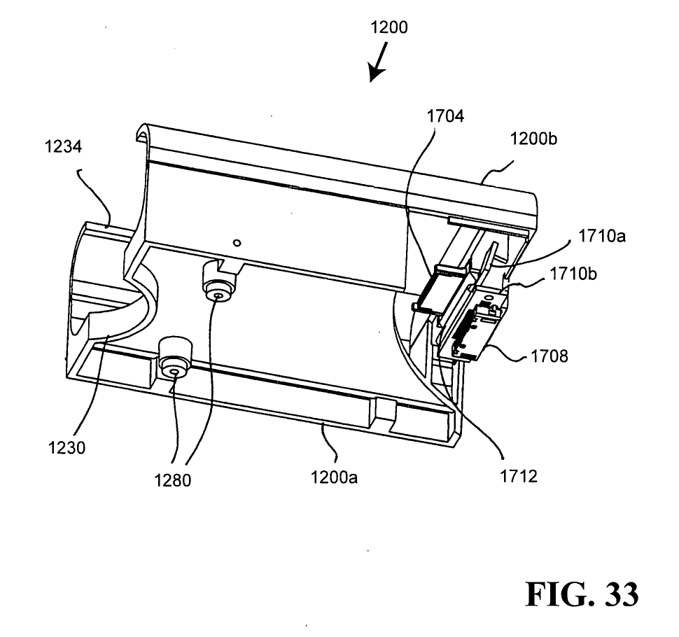

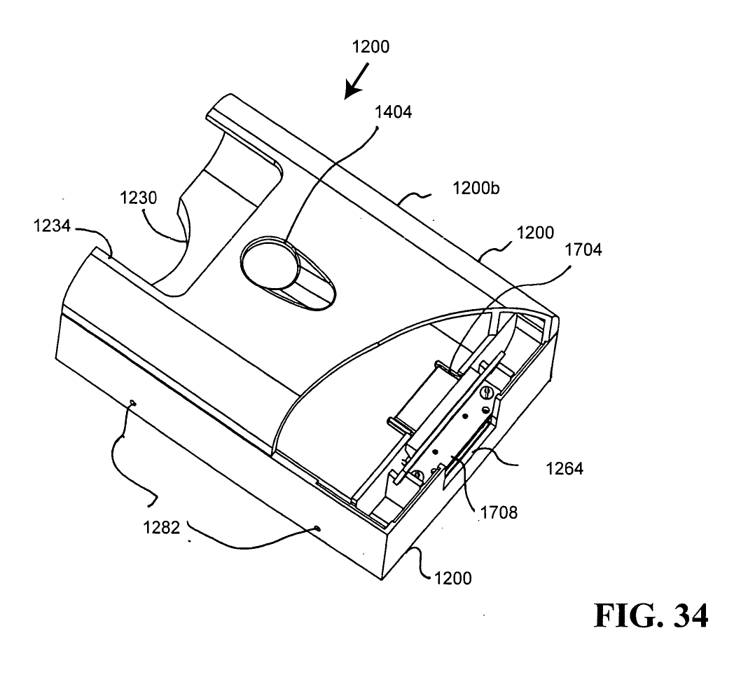

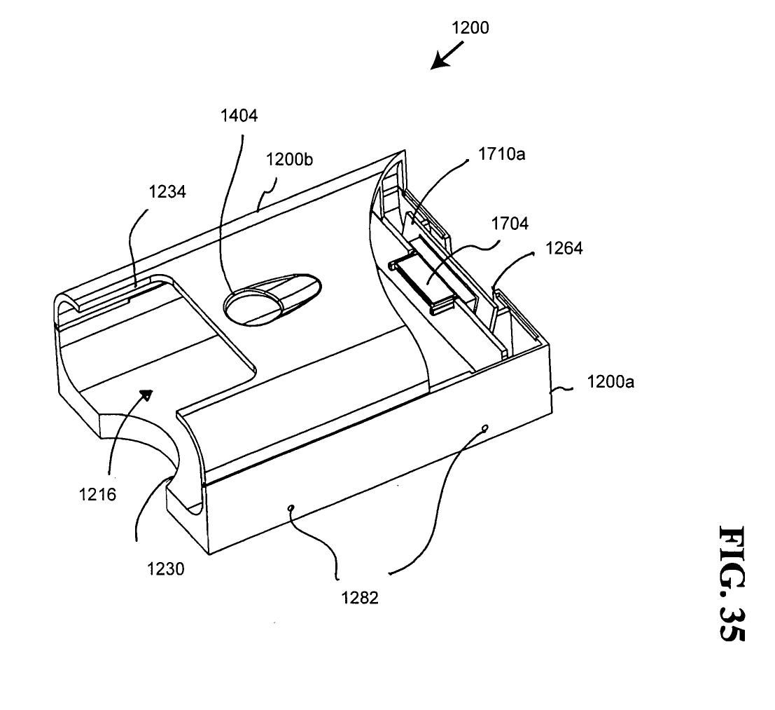

FIG. 27 to FIG. 35 illustrates a mounting system 1100 configured in accordance to another preferred embodiment of the present invention, wherein like numerals in the components of mounting system 1110 shown FIG. 27 to FIG. 35 refer to like parts throughout FIG. 1 to FIG. 26 but differentiated by using an 1000-series of numbers. Thus, for example, the description contained herein for sleeve 200 is equally applicable to sleeve 1200, except where otherwise noted.

In one preferred embodiment, sleeve 1200 is comprised of a base 1200a and a top cover 1200b. Base 1200a includes a series of mounting posts 1280 such that a series of screws may be used to secure base 1200a to a surface where mounting system 1200 is to be mounted. Base 1200a also includes a series of side mounting holes 1282 such that a series of screws may be used to secure base 1200a to a surface where mounting system 1200 is to be mounted in another mounting configuration.

Further, a system connector 1708, preferably a ribbon cable connector, is used to provide connectivity to the electronics in mounting system 1200. A pair of circuit boards 1710a and 1710b are used to provide connectivity between a connector 1704 and system connector 1708. In one preferred embodiment, a ribbon interconnect cable 1712 is used to electrically couple pair of circuit boards 1710a and 1710b. Further, connector 1704 includes a bottom portion 1704a and a top portion 1704b.

The embodiments described above are exemplary embodiments of a the present invention. Those skilled in the art may now make numerous uses of, and departures from, the above-described embodiments without departing from the inventive concepts disclosed herein. Accordingly, the present invention is to be defined solely by the scope of the following claims.

What is claimed is:

1. A mounting system for a vehicle compartment having an entertainment system, the entertainment system including an interface for communicating with the entertainment system comprising:
a sleeve mounted to the vehicle compartment, the sleeve having an inner portion and an opening disposed on one wall thereon;
an insert having an outer portion configured to slide into and be retained by the inner portion of the sleeve through the opening and a locking mechanism configured to disengageably couple the insert to the sleeve, the insert also including an inner portion configured to receive a multimedia playback device; and,
a device interface circuit coupled to the sleeve, the device interface circuit providing an interface between the entertainment system and the multimedia playback device.

2. The mounting system of claim 1, wherein the device interface circuit includes a connector coupled to the interface of the entertainment system and configured to couple to a mating connector on the multimedia playback device.

3. The mounting system of claim 2, wherein the insert includes a connector opening therein through which the connector passes through.

4. The mounting system of claim 1, wherein the locking mechanism comprises a tab having a button formed thereon.

5. The mounting system of claim 4, wherein the sleeve includes a locking mechanism receptor opening having a shape configured to match a cross section of the button.

6. The mounting system of claim 4, wherein the button is a cylindrically shaped structure.

7. A method for interfacing a multimedia player device to an entertainment system in a vehicle, the method comprising the steps of:
installing a sleeve in the vehicle, the sleeve having an interface circuit coupled to the entertainment system;
disengageably locking an insert into the sleeve, the insert having an interior configured to receive the multimedia player device; and,
inserting the multimedia player device into the interior of the sleeve.

8. The method of claim 7, further comprising the step of connecting the multimedia player device to the interface circuit

9. The method of claim 8, wherein the step of connecting the multimedia player device to the interface circuit comprises the step of coupling a connector mounted to the sleeve to a matching connector on the multimedia player device.

10. The method of claim 7, wherein the step of disengageably locking an insert into the sleeve includes the step of inserting a button on the insert into a button opening on the sleeve.

11. The method of claim 10, wherein the button opening having a shape configured to match a cross section of the button wherein the button is a cylindrically shaped structure.

12. The method of claim 10, wherein the button is a cylindrically shaped structure.
